(19) United States
(12) Patent Application Publication
(10) Pub. No.: US 2021/0097338 A1
(43) Pub. Date: Apr. 1, 2021

(54) Using Domain Constraints And Verification Points To Monitor Task Performance

(71) Applicant: International Business Machines Corporation, Armonk, NY (US)

(72) Inventors: Vijay Kumar Ananthapur Bache, Bangalore (IN); Smitkumar Narotambhai Marvaniya, Bangalore (IN); Vijay Ekambaram, Chennai (IN); Sarbajit K. Rakshit, Kolkata (IN)

(21) Appl. No.: 16/583,362

(22) Filed: Sep. 26, 2019

(51) Int. Cl. G06K 9/62; G06K 9/00

(52) U.S. Cl. CPC G06K 9/6256; G06K 9/00744; G06K 9/00771; G06K 9/6263

(57) ABSTRACT

Technology for: receiving training data sets for a physical task performed by a set of human(s), with each training data set including: (i) a plurality of streams of sensor input, and (ii) an identification of a time of a first verification point instance; defining, by machine logic, a first verification point definition, with the first verification point definition including a plurality of parameter value ranges; monitoring, by a plurality of active sensors, an instance of the physical task as it is being performed by a set of human(s) to obtain a set of sensor stream parameter value(s) for each sensor of the plurality of active sensors; and determining, by machine logic, an occurrence of a first instance of the first verification point based on the plurality of parameter ranges of the first verification point definition and the set of sensor stream parameter value(s).

### BACKGROUND

The present invention relates generally to the field of monitoring worker(s) (for example, players on a professional sports team) in performing a work task (for example, performing a sports play).

It is known to use sensor input (for example, moving images captured by video camera(s)) to automatically determine the progress of a user performing a task (for example, making a food according to a food recipe).

For example, US Patent Application publication number 2018/0268865 discloses as follows: “[I]nstructor-action-semantics, that is a set of tags or action steps, are attached to an instructional video at points along the instructional video stream, and activity monitors are used to identify when the user is performing tasks that match a particular instructor-action-semantic (i.e., tag or action step) in the process of performing the steps. As explained herein, there are several techniques for employing monitoring mechanisms, such as mobile or wearable monitoring mechanisms, in order to learn where a user is within a series of activities that will need to be performed when following an instructional video. . . . As illustrated, the process may include obtaining data from one or more activity sensors or monitors proximal to the instructional video user . . . and as noted, the one or more sensors may include one or more video monitors that monitor the user's progress through the series of steps, as well as, for instance, one or more activity monitors, such as wearable sensors, smartwatches, smart glasses, etc. as well as (for instance). In addition, one or more object or device sensors, such as one or more home or kitchen sensors in the case of a cooking instructional video, may be employed. For instance, in one or more implementations, Internet of Things (IoT) sensors may also be used. Human activity modality is detected and fed to the cognitive video rendering engine. Various technologies exist which can facilitate detecting user activity or modality. For instance, objects in a smart kitchen may emit identifiers through radio frequency channels, and based on this information, it can be determined which objects within the kitchen the user is interacting with. For instance, ‘the user interacted with salt container.’ By correlating the activity modalities of the user with various interacting objects in the environment (e.g. which emit identifiers) software can determine various semantics of the user-action steps. These smart collected user-action-semantics may be fed to the cognitive system.”

It is known to use a 360° camera (or set of cameras) to monitor or a user who is performing a mechanical task (for example cooking a food item according to a food recipe).

For example, U.S. Patent Application Publication number 2019/0191146 discloses as follows: “A multiple viewpoint image capturing system includes: a plurality of cameras that capture videos in a predetermined space from different positions . . . The present disclosure relates to a technique for calibrating a plurality of cameras that capture videos used for three-dimensional space reconstruction. . . . There is a demand for a multiple viewpoint image capturing system that provides three-dimensional space reconstruction and three-dimensional space recognition that are more stable in accuracy and availability. . . . Generation of a free-viewpoint video in a three-dimensional shape uses a result of three-dimensional space reconstruction performed by a three-dimensional space reconstructing device that reconstructs (models) a three-dimensional shape of a subject. The three-dimensional space reconstructing device performs the modeling using video data that is provided from a multiple viewpoint image capturing system including a plurality of cameras to capture videos of the same scene . . . A conceivable method is thus one in which the three-dimensional space reconstruction is appropriately performed by fixing the cameras during the calibration and the capturing so as not to change a position or the like of a camera after the calibration. Such a method however can be used only in limited environments . . .”

### SUMMARY

According to an aspect of the present invention, there is a method, computer program product and/or system that performs the following operations (not necessarily in the following order): (i) receiving a plurality of training data sets for a physical task performed by a set of human(s), with each training data set including: (a) a plurality of streams of sensor input respectively received from a plurality of sensors over a common period of time, with each stream of sensor input including a plurality of sensor input values ordered in time, and (b) an identification of a time of a first verification point instance corresponding to first intermediate event typically occurring within the performance of the physical task performed by human(s); (ii) defining, by machine logic, a first verification point definition, with the first verification point definition including a plurality of parameter value ranges, with each parameter value range corresponding to a range of values in the stream of sensor input received from a sensor of the plurality of sensors that corresponds to an instance of the first verification point when the physical task is performed by a set of human(s); (iii) monitoring, by a plurality of active sensors, an instance of the physical task as it is being performed by a set of human(s) to obtain a set of sensor stream parameter value(s) for each sensor of the plurality of active sensors; (iv) determining, by machine logic, an occurrence of a first instance of the first verification point based on the plurality of parameter ranges of the first verification point definition and the set of sensor stream parameter value(s); and (v) responsive to the determination of the occurrence of the first instance of the first verification point, taking a responsive action.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a flowchart showing a second embodiment of a method according to the present invention; and

FIG. 6 is a flowchart showing a third embodiment of a method according to the present invention.

### DETAILED DESCRIPTION

Some embodiments of the present invention are directed to the use of supervised machine learning to determine a set of relevant parameters and associated parameter ranges (that is a range of parameter value, or a single) for the relevant parameters that corresponds to a “verification point.” The verification point is a juncture in the physical task performed by humans that is a meaningful juncture with respect to evaluating the quality of performance of the task. For example, subsection II of this Detailed Description section will deal with a verification point example where the verification point is the disposal of waste oil during an oil change procedure. As a further example, subsection III this Detailed Description section will deal with a verification point example where the verification points correspond to various junctures in cooking a recipe for vegetable biryani. The relevant parameters and associated parameter ranges for a given verification point are sometimes herein referred to as “domain constraints.”

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

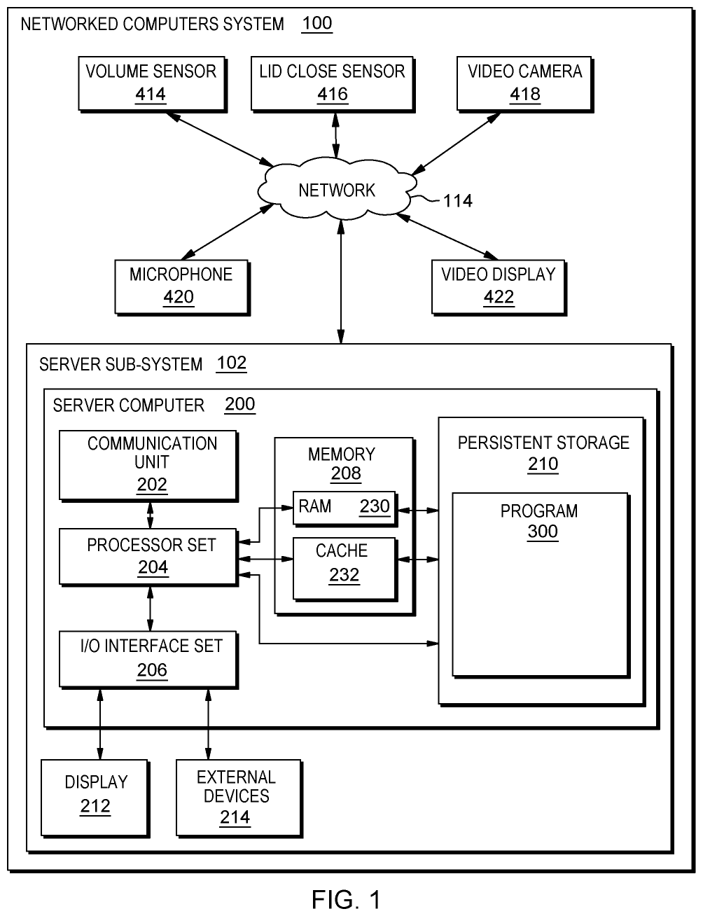

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); volume sensor 414; lid close sensor 416; video camera 418; microphone 420; video display 422; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

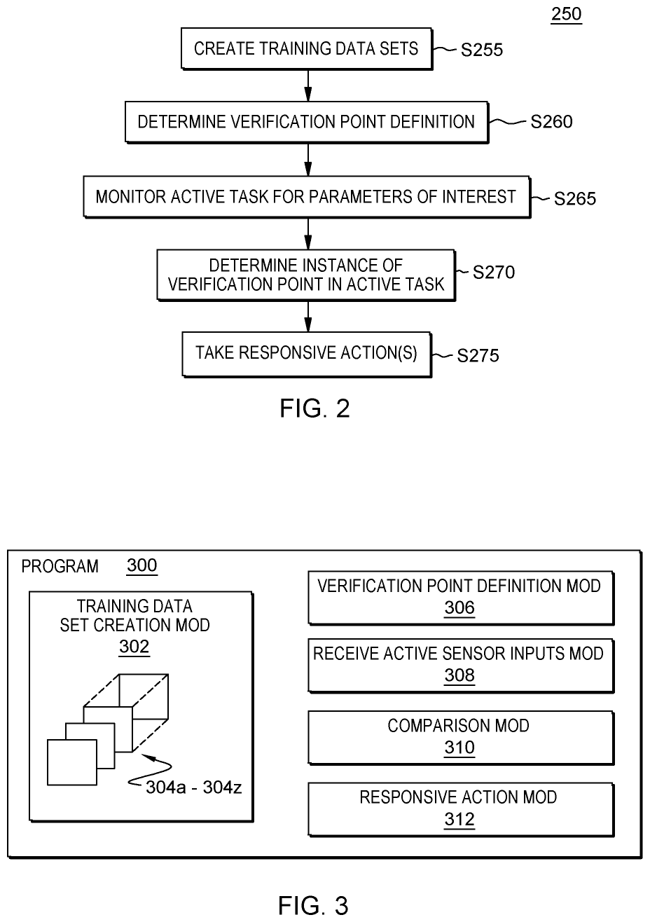

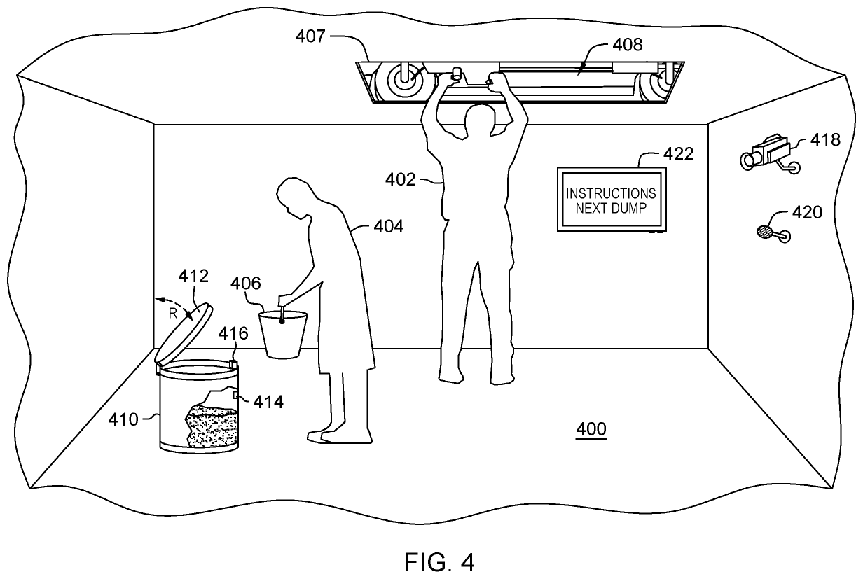

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. FIG. 4 shows environment 400 in which the task of changing the oil for a motor vehicle is performed by a team of human individuals. This method and associated software will now be discussed, over the course of the following paragraphs, with extensive reference to the blocks of FIGS. 1, 2, 3 and 4.

Processing begins at operation S255, where training data set creation module (“mod”) 302 creates training data sets 304a to 304z. When they are first received, each training data set includes multiple streams of sensor input respectively received from a multiple sensors during the time that teams of employees have historically performed the task of doing an oil change on a motor vehicle. In this example, the four streams of sensor data included in each training data set are as follows: (i) a stream from a lid close sensor that provides a pulse in its output signal whenever the lid of a waste oil receptacle is opened or shut; (ii) a stream from a volume sensor that provides an output signal indicative of the volume of waste oil currently in the waste oil receptacle; (iii) a stream from a video camera that is aimed at the area where the waste oil receptacle is; and (iv) a stream from a microphone that is positioned to pick up ambient sound in the area where the oil change task is being performed. Each training data set corresponds to a different instance where an oil change was successfully performed. The time scale associated with each training data set is the period of time over which the oil change was successfully performed. During each of these oil change task instances, one juncture of the task occurs when waste oil from the motor vehicle is disposed of in the waste oil receptacle. As will be discussed with respect to subsequent operations of flowchart 250, this waste oil disposal juncture in the larger task of the oil change is a “verification point,” and the definition and detection of this verification point is the focus of the example currently under discussion.

Processing proceeds to operation S260, where verification point definition mod 306 determines the definition of the waste oil disposal verification point with respect to output of one, or more, of the four sensor output signals available. This verification point definition generally includes: (i) determining which of the four sensor output signals are relevant to the determination of instances of the verification point; and (ii) for the relevant sensor output signal(s), determining parameter ranges that reliably indicate an instance of the waste oil disposal verification point.

A first part of operation S260, human individuals working as machine logic trainers determine, for each training data set, the time point in the timescale at which the waste oil has been successfully disposed. The human trainers may determine this by watching the video sensor output signal of the training data set being evaluated and/or using the other sensor output streams. The human trainers should have sufficient expertise in the task of changing oil so that they have no problem in identifying instances of the juncture of the task at which the waste oil is successfully disposed of.

As a second part of operation 5260, the machine logic of verification point definition mod 306 determines which of the four sensor output streams are relevant with respect to defining the verification point. In this example: (i) the video sensor output signal is determined not to be relevant (because oil change employees frequently pass near the waste oil receptacle and also because these passing employees often block the view of the lid of the waste oil receptacle); (ii) the microphone sensor output signal is determined not to be relevant because there are no characteristics sounds, or aspects of sounds (for example frequency, sound volume); (iii) the lid close sensor output stream is determined to be relevant because there is a relatively high degree of correlation between the lid opening and/or closing and the completion of disposal of the waste oil; and (iv) the volume sensor output stream, that detects volume of oil in the waste receptacle, is determined to be relevant because there is a relatively high degree of correlation between an increase of volume of waste oil in the waste oil receptacle and the completion of disposal of the waste oil during the oil change task.

The concept of “fused outputs,” also called “use of multiple parameters,” will now be discussed. In this simple example, the parameter of whether the receptacle lid has been opened/shut is not sufficient, in and of itself, to reliably detect whether the waste oil disposal verification point has occurred. One reason for this, in this example, is that the lid close sensor does not distinguish between opening the lid and closing the lid. Another reason for this is that the lid is occasionally opened and/or shut for reasons other than disposing of waste oil. In this simple example, the parameter of waste oil volume in the waste oil receptacle is not sufficient, in and of itself, to reliably detect whether the waste oil disposal verification point has occurred. The main reason for this, in this example, is that waste oil may be pumped into and/or out of the waste oil receptacle when the lid is closed (for example, when the waste oil receptacle is getting filled up in another adjacent service bay, waste oil may be pumped from that receptacle into the waste oil receptacle of the training data set). While neither one of the parameters of lid action and waste oil volume is sufficient to reliably determine an instance of the waste oil disposal verification point, when these two parameters are considered in conjunction, it does become possible to reliably determine instances of the waste oil disposal verification point, as will be discussed in more detail below. As will be discussed in the following subsection of this Detailed Description section, more sophisticated systems may fuse output streams from more than two sensors (for example, multiple cameras in a 360° video set up).

Now it will be discussed in more detail how the following two parameters are fused in this example: (i) lid close sensor output pulses; and (ii) waste oil receptacle volume sensor signal. Verification point definition mod 306 determines a machine logic-based rule that the waste oil disposal verification point has occurred when an increase in oil volume in the waste oil receptacle is followed, within at most thirty seconds, by a lid open/close pulse. In human understandable terms, the waste oil volume increased corresponds to an oil change employee boring waste oil into the receptacle, followed by the oil change employee closing the lid of the waste oil receptacle to avoid spills and other accidents. While the volume of the waste oil may increase from having oil pumped into the waste of the receptacle, these instances of oil being pumped in will not be followed within thirty seconds by an opening of the lid, which is automatically down during and immediately after any pumping operations.

Processing proceeds to operation S265, where receive active sensory inputs mod 308 monitors a current instance of an oil change task or parameters of interest with respect to the waste oil disposal verification point. The current instance of the oil change task is shown in oil change task environment 400 of FIG. 4. Environment 400 includes: first oil change employee 402; second oil change employee 404; waste oil transfer bucket 406; underside of motor vehicle 408; vehicle underside exposure aperture 407; waste oil receptacle 410; waste oil receptacle lid 412 (which rotates between open and shut positions in the direction of R); waste oil volume sensor 414; lid close sensor 416; video camera 418; microphone 420; and video display 422.

In this simple example, mod 308 is monitoring the outputs of a lid close sensor 416 and waste oil volume sensor 414, because these are the two parameters of interest (or “domain constrained parameters”) with respect to automatically detecting by machine logic (as opposed to detecting by a human trainer) a current instance of the waste oil disposal verification point in the oil change task. In more complicated embodiments, additional verification points may be detected, and all four sensors may come into play. At the time of the view shown in FIG. 4, employee 404 has just poured additional waste oil into waste oil receptacle 410, and, in response, volume sensor 414 has sent an output signal indicating an increase in the volume of waste oil in receptacle 410. This increase is detected by mod 308. Also, lid 412 has started to rotate into the shut position, but it has not yet fully shut, meaning that mod 308 has not yet received a lid action pulse in the output signal of lid close sensor 416.

Processing operation 5270, where comparison mod 310 determines if the waste oil disposal verification point in the currently active oil change task progress, based on: (i) the parameter ranges of the verification point definition previously determined at operation S260; and (ii) the sensor output streams being monitored by mod 308. More specifically, in this example, mod 310 has determined that lid 412 has fully shut within thirty seconds after an increase in waste oil volume and receptacle 410. The relevant parameter ranges (or “domain constraints”) here are as follows: (i) there is an increase of more than 0 gallons in waste oil volume; (ii) there is a lid action pulse (bear in mind that a “parameter range” can be a single value as the term “parameter range” is used in this document—here the lid action pulse corresponds to a value of 1, instead of 0); and (iii) the time between the non-zero increase and lid action pulse is between 0.0 and +30.0 seconds. A current instance of the waste oil disposal verification point has now been automatically detected by machine logic. It is noted that sensor output parameters may be related to time, space (for example, location or volume of objects), mass, radiation, sound, chemical composition or reaction, and/or any other detectable physical phenomena now known or to be developed in the future).

Processing proceeds to operation S275, where the responsive action mod 312 takes a responsive action in response to the detection of the waste oil verification. In this example, the responsive action is generation and display of a screenshot with further instructions regarding oil change task operations that occur subsequent to the dumping of the waste oil. Because the current instance of the waste oil disposal verification point has been reached, employees 402, 404 are now ready for instructions on further operations as they proceed through the current oil change task.

### III. Further Comments and/or Embodiments

Some embodiments of the present invention recognize the following facts, potential problems and/or potential areas for improvement with respect to the current state of the art: (i) it is not necessarily readily apparent how an end user can be guided to perform the authentic cooking activities while watching a recipe video; (ii) existing systems increase/decrease the frame rate of a recipe video to help users while performing cooking; (iii) existing systems compares the videos frame by frame for action or activity matching; (iv) existing methods/systems do not have machine logic to identify the validation points which helps in verifying the user's cooking activity based on viewing angle and distance using head-mounted cameras such as Google Glass; (v) one challenge is identifying the validation points along with capturing the meta information such as viewing angle and distance while shooting the professional video; (vi) another challenge is guiding end user's to capturing the current cooking state by suggesting the viewing angle and distance such that one can efficiently verify the cooking step; and/or (vii) another challenge is efficiently verifying the video frames based on the validation points which helps user to guide and perform the correct cooking activity.

Some embodiments of the present invention may include one, or more, of the following operations, features, characteristics and/or advantages: (i) system and method for identifying and verifying the cooking state using smart glasses in smart kitchen; (ii) a novel system and method for effectively auto-capturing verification points in 360 degree cooking videos with saved viewing angle/distance from capturing device, so that it could be easily replicated in end user's wearable glass for guiding the user during the verification points for easy validation of the cooking steps; (iii) automatically identifying and capturing visual frames in 360 degree smart cooking video; (iv) for auto-verification (at client end) based on keyword utterances and also determining viewing; (v) angles/directions and number of capturing poses based on keyword utterance classification inferences; (vi) system captures the 360 degree video while user is performing the cooking activity in a smart kitchen environment; (vii) semantic segmentation is performed by using the keyword utterances for identifying the set of events in the cooking video; (viii) supervised classification based method identifies the important events as a verification events for performing authentic cooking activity; (ix) based on the verification event's content, system identifies the set of metadata that needs to be captured to represent the events efficiently and this metadata will be used for verifying the cooking event. For example to verify the quantity/size information system identifies object information needs to be captured from more than three viewing angles; (x) when user watches the two-dimensional video, system streams the verification points and its associated meta-data (viewing angle/distance, number of captures) to user's wearable glass and an app in the wearable glass will guide the user to take snapshots based on the streamed meta-data (that is viewing angle, distance, number of capture points) and does auto comparison of the snapshots with the snapshots of the original 360° video for validation of the verification points; (xi) system identifies the verification event by analyzing the user's cooking state; (xii) captures the metadata for verifying the verification points, system guides user to capture video frames from different viewing angles and at certain distance; and/or (xiii) supervised classification method compares verification points by comparing the video frames along with metadata that helps in performing the cooking event at high accuracy.

System context for an embodiment of the present invention will now be discussed. A first group of context elements include a smart kitchen, a camera, a multiview video content, user interactions and smart glasses. A second group of context elements include an artificial intelligence enabled video understanding system. A third group of context elements includes: identification of various verification points in 360° video; capturing of metadata information such as viewing angle, distance while shooting professional cooking video; and a system to guide an end user to capture the various metadata for verifying the cooking activity efficiently. The inputs (from the first group of context elements) include a video feed (camera), video content and user interactions. The outputs (from the third group of context elements) include identification of verification point and guiding end user to capture metadata for efficiently comparing cooking activity.

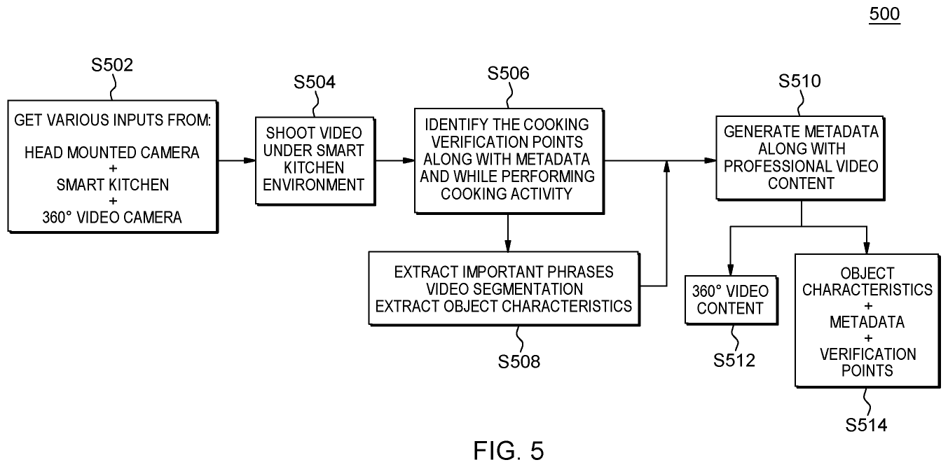

As shown in FIG. 5, flowchart 500 represents a method according to the present invention including the following operations, with process flow among and between various operations being as shown in FIG. 5: S502; S504; S506; S508; S510; S512; and S514.

Shooting video in a smart kitchen environment will now be discussed. Professional video is shot where multiple cameras are capturing the user's actions/activities. Based on the audio content, and artificial intelligence (AI) agent identifies the important objects and their characteristics. For example, for a Biryani recipe, one can specify the size of the onions, potatoes, and other ingredients, and then the AI agent captures size/weight/characteristics of the object more closely by identifying the viewing angle which is best suited for capturing these attributes. The system automatically identifies the verification points by looking at the audio utterance information. For example, some of the events identify the size/weight information of the objects. At the end, the system captures to 360° video content along with object characteristics in terms of metadata.

Important phrases in the video, for one embodiment of the present invention, are as follows: (i) vegetable biryani recipe; (ii) in a pan add oil, to which add garam masala, dried onion and boiling water salt to taste, yogurt and soaked recipe (which is soaked for 20 minutes); (iii) cook until the rice is half cooked and drain the remaining water—add yellow color to the rice; (iv) to make the vegetables, to a pan add oil, garam masala, fried onion, tomatoes, turmeric, red chili powder, salt, cauliflower, French beans, carrots, little bit of yogurt mix them properly and add some water and add green peas; (v) once the vegetables are done, assemble them in larger pan and place paneer on the vegetables, after that add the rice over the vegetables and keep the biryani on low flame for 10 minutes; (vi) garnish it with fried onions, pomegranate seeds and fresh mint leaves; and (vii) vegetable biryani is ready to be served.

A method of capturing object characteristics and verification points through an AI agent will now be discussed. First, a multi-camera video feed including a 360° video and video from a head-mounted camera is received, along with associated audio that is captured by one or more microphones. Next, object characteristics are captured from video and audio signals. Then, capture some of the important characteristics of the objects in a video (for example in a biryani recipe video identify the size of the onions, potatoes, etc.). by connecting the video with audio frame. Next, the viewing angles from different cameras are identified and connected in such a way that object properties are captured in a best position. Next, the relationship across the objects is identified and the time sequencing information is extracted (for example, proportion of the onion and potato could be very useful information while preparing a biryani. Next, various verification points are identified in the 360° video.

A process for identifying the verification points, along with metadata, will now be discussed. Consider a 360 degree video V will be shot while preparing the cooking activity. The following steps are performed to identify the verification points and link the metadata with the video signals: step 1: extract audio frame from video and convert audio into text; step 2: identify important phrases using deep recurrent neural network; and step 3: perform video segmentation based on semantic segmentation based on important phrases. Step 3 includes the following sub-steps: perform semantic segmentation on video based on context information. The context information is identified from audio signals; and video V is segmented into set of video shots, V→{v₁, v₂, v₃, . . . , vₖ}. The important events are identified by analyzing the audio utterances by training a classifier. Inputs include: audio utterance, video signals, and corresponding text information for t to t+k time segments. Outputs include: [0, 1]→1 is considered with respect to the verification points, and a value of 0 is not needed for considering the verification point. This embodiment trains a binary classifier which takes the audio utterance and predicts that whether this event is an important event or not. Mathematical expression (1) is as follows:

Ø_{verification}^{predictor}−point(V_{t,t,+k}, A_{t,t+k}, T_{t,t+k}): [0,1]

Identification of the important metadata information for the verification points (that is, defining the parameters of sensor data that correspond to a verification point in a task that is being performed) will now be discussed. Once a given cooking event has been identified as an important verification point then the important metadata based on the event is identified. Some event requires minimum three views to capture the metadata such as quantity/weight of the object can be captured by efficiently capturing the state from different viewing angle. A classifier is trained, which takes the cooking activity as an input and predicts the list of important metadata that are important for capturing this cooking event. Inputs include: audio signals, video signals, important phrases. Outputs include: metadata information. Expression (2) is as follows:)

Ø_{metadata}^{predictor}(Vₜ, Aₜ,Tₜ)→[Metadata₁→{0,1}, Metadataₜ→{0,1}]

To describe the particular metadata information, the information is identified, such as best viewing angle, distance, video frames capturing important object information. For example, important metadata information can be represented as:

Object _{c1}ⁱ→ViewingAngle₁, ViewingAngle₂, ViewingAngle₃.

Object_{c1}ⁱ→Distance₁

Eventᵥⁱ→Distance_{d}, ViewingAngle_{α}

The action and time dependencies are then identified. The time information is extracted, such as how much time one has to fry the onions while preparing for biryani. Some of the metadata is extracted, like what the temperature of the oil is while cooking. One can connect the sensors installed in the kitchen with video such that the temperature of the oil can be determined at any time while preparing a cooking recipe.

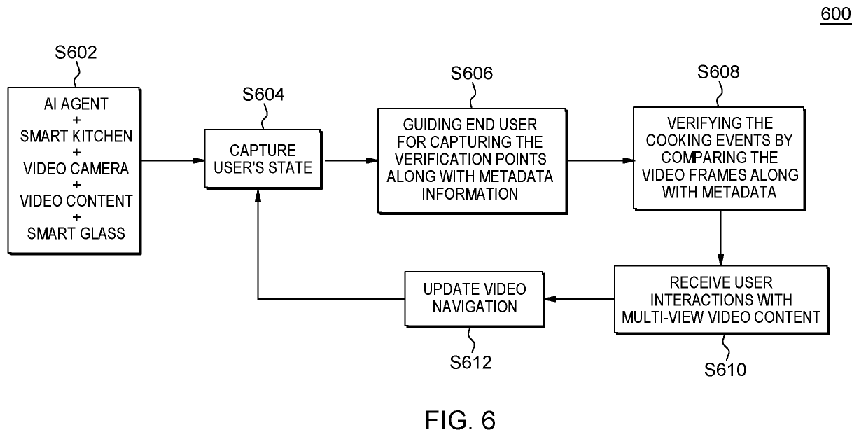

As shown in FIG. 6, a flow chart 600, according to a method of the present invention, includes the following operations (with process flow among and between the operations shown by arrows in FIG. 6): S602; S604; S606; S608; S610; and S612.

How to capture user's interaction/activities will now be discussed. A list of things can be used to infer the user's state is as follows: video feed through static camera; user action/activity; user interaction with objects; real-time video feed using smart glasses that helps in capturing the video; frame information from multiple views; and depth information.

User interactions for capturing the metadata for verification points may include one, or more, of the following operations: (i) receive input data streams from various sensors, such as 360° camera set and/or head-mounted camera; (ii) understand user's interactions; (iii) capture user's activity through audio and video signals through camera; (iv) identifies the gap between user's activity/actions and the activity shot in recipe video; (v) guide user to capture the necessary metadata information for the verification point; (vi) allow user to interact with content like asking questions such as size of the objects or some characteristics of the objects; (vii) capture user's activity/action through static camera (Video+Audio) and google glass when user is preparing a cooking activity; (viii) AI agent suggest user to capture video frame from expected angle by analyzing the video feed extracted using head-mounted camera: (ix) the important characteristics of the objects and relationship across the objects are already captured in the recipe video; (x) introduce AI agent which reads the user's interactions/activity in terms of video and audio signals and identify a verifying point where user has to get some additional information; and/or (xi) the AI agent suggests end user to capture the video frames from a particular angle and a distance such that important aspect of the cooking is covered and verified.

Verification of the user's cooking action may include one or more, of the following operations: (i) system has automatically identified set of verification points along with necessary metadata for capturing the particular cooking state; (ii) perform set of operations for verifying the cooking events: (a) step-1: read user's activity/action using smart glasses, (b) step-2: system suggest viewing position for efficiently capturing user state through smart glasses, and (c) step 3: verifies the cooking state by comparing the video frames along with metadata information; and/or (iii) perform above operations to guide user to capture metadata information and verifies all important cooking states.

Reading the user's activities and/or actions using a head-mounted camera (for example, smart glasses) may include one, or more, of the following operations: (i) read the user's action/activity through video signals using static video feed and multi-view video content using smart glasses; (ii) extract some of the important characteristics of the objects from the live video feed and use smart glasses for capturing user's state efficiently through multi-view video content; (iii) in professional video, system automatically identifies set of verification points which user has to authenticate while preparing cooking (for example, while user is preparing a biryani one can read the size of the onion, and potato); (iv) infer the ratio (object characteristics can be estimated at various point in time); (v) system identifies the some of the important object characteristics needs to be verified; and/or (vi) compare the object characteristics and identify the turning point where AI agent gets triggered and guide user to capture certain object characteristics. For performing operation (v), the following expression may be used:

Ø_{verification-point}^{predictor}(V_{metadata,t}^{user}, V_{metadata}^{professional-video})→[0, 1]

One, or more, of the following operations may be used to suggest viewing positions for efficiently capturing user state through smart glasses: (i) in order to capture some of the events such as quantity, size of the objects, view point where smoke is visible while performing cooking AI agent captures the current user's state and compare with recorded 360 degree video content and recommend some of the viewing position where one can capture user's state efficiently; (ii) train a classifier that takes video frames taken from google glass and static camera as an input along with recorded video; (iii) predict whether video frames that needs to be captured from different viewing angle; (iv) receive the inputs identified below; and/or (v) determine the outputs identified below. The inputs for operation (iv) are as follows:

Vᵢ^{user-static}: Video frames captured using statice camera

Vᵢ^{user-google-glass}: Video frames captured using google glass

V_{c1}^{professional-video}: Professional video frames that are relevant to user's state

The outputs for operation (v) are as follows:
Output-1:
[0→1]: 0 means no need for extra video frame. 1 means required video frames.
Output-2:
[α₁,αₖ]: Video frames needs to be captured for these viewing angles using google glass.
Classifier-1:

Ø_{vidoeframe}^{required}(Vᵢ^{user-static}, Vᵢ^{user-google-glass}, V_{c1}^{professional-video})
Classifier-2:

Ø_{videoframe}^{positon}(Vᵢ^{user-static}, Vᵢ^{user-google-glass}, V_{c1}^{professional-video})

Some embodiments of the present invention may include one, or more, of the following operations, features, characteristics and/or advantages: (i) a novel system and method for effectively auto-capturing verification points in 360 degree cooking videos with saved viewing angle/distance from capturing device, so that it could be easily replicated in end user's wearable glass for guiding the user during the verification points for easy validation of the cooking steps; (ii) automatically identifying and capturing visual frames in 360 degree smart cooking video; (iii) for auto-verification (at client end) based on keyword utterances and also determining viewing angles/directions and number of capturing poses based on keyword utterance classification inferences; (iv) system captures the 360 degree video while user is performing the cooking activity in a smart kitchen environment; (v) semantic segmentation is performed by using the keyword utterances for identifying the set of events in the cooking video; (vi) supervised classification based method identifies the important events as a verification events for performing authentic cooking activity; (vii) based on the verification event's content, system identifies the set of metadata that needs to be captured to represent the events efficiently and this metadata will be used for verifying the cooking event (for example, to verify the quantity/size information system identifies object information needs to be captured from more than three viewing angles); (viii) when user watches the two-dimensional video, system streams the verification points and its associated metadata (viewing angle/distance, number of captures) to user's wearable glass and an app in the wearable glass will guide the user to take snapshots based on the streamed meta-data (that is viewing angle, distance, number of capture points) and does auto comparison of the snapshots with the snapshots of the original 360 degree video for validation of the verification points; (ix) system identifies the verification event by analyzing the user's cooking state; (x) capture the metadata for verifying the verification points, system guides user to capture video frames from different viewing angles and at certain distance; and/or (xi) supervised classification method compares verification points by comparing the video frames along with metadata that helps in performing the cooking event at high accuracy.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a plurality of training data sets for a physical task performed by a set of human(s), with each training data set including: (i) a plurality of streams of sensor input respectively received from a plurality of sensors over a common period of time, with each stream of sensor input including a plurality of sensor input values ordered in time, and (ii) an identification of a time of a first verification point instance corresponding to first intermediate event typically occurring within the performance of the physical task performed by human(s);
defining, by machine logic, a first verification point definition, with the first verification point definition including a plurality of parameter value ranges, with each parameter value range corresponding to a range of values in the stream of sensor input received from a sensor of the plurality of sensors that corresponds to an instance of the first verification point when the physical task is performed by a set of human(s);
monitoring, by a plurality of active sensors, an instance of the physical task as it is being performed by a set of human(s) to obtain a set of sensor stream parameter value(s) for each sensor of the plurality of active sensors;
determining, by machine logic, an occurrence of a first instance of the first verification point based on the plurality of parameter ranges of the first verification point definition and the set of sensor stream parameter value(s); and
responsive to the determination of the occurrence of the first instance of the first verification point, taking a responsive action.

2. The CIM of claim 1 wherein the responsive action is the playing of a predetermined video for the set of human(s) performing the instance of the physical task.

3. The CIM of claim 1 further comprising:
prior to the receiving of the receiving a plurality of training data sets and for each given training data set of the plurality of training data sets, identifying, by a human supervisor, the time of the first verification point instance.

4. The CIM of claim 1 wherein the physical task relates to one of the following areas: cooking, equipment repair, equipment maintenance and/or product assembly.

5. The CIM of claim 1 wherein the plurality of active sensors include a plurality of video cameras positioned to provide 360 degree visual coverage of the instance of the physical task.

6. The CIM of claim 1 wherein the plurality of active sensors include: at least one video camera, and (ii) at least one audio microphone.

7. A computer program product (CPP) comprising:
a set of storage device(s); and
computer code stored collectively in the set of storage device(s), with the computer code including data and instructions to cause a processor(s) set to perform at least the following operations:
receiving a plurality of training data sets for a physical task performed by a set of human(s), with each training data set including: (i) a plurality of streams of sensor input respectively received from a plurality of sensors over a common period of time, with each stream of sensor input including a plurality of sensor input values ordered in time, and (ii) an identification of a time of a first verification point instance corresponding to first intermediate event typically occurring within the performance of the physical task performed by human(s),
defining, by machine logic, a first verification point definition, with the first verification point definition including a plurality of parameter value ranges, with each parameter value range corresponding to a range of values in the stream of sensor input received from a sensor of the plurality of sensors that corresponds to an instance of the first verification point when the physical task is performed by a set of human(s),
monitoring, by a plurality of active sensors, an instance of the physical task as it is being performed by a set of human(s) to obtain a set of sensor stream parameter value(s) for each sensor of the plurality of active sensors,
determining, by machine logic, an occurrence of a first instance of the first verification point based on the plurality of parameter ranges of the first verification point definition and the set of sensor stream parameter value(s), and
responsive to the determination of the occurrence of the first instance of the first verification point, taking a responsive action.

8. The CPP of claim 7 wherein the responsive action is the playing of a predetermined video for the set of human(s) performing the instance of the physical task.

9. The CPP of claim 7 wherein the computer code further includes instructions for causing the processor(s) set to perform the following operation:
prior to the receiving of the receiving a plurality of training data sets and for each given training data set of the plurality of training data sets, identifying, by a human supervisor, the time of the first verification point instance.

10. The CPP of claim 7 wherein the physical task relates to one of the following areas: cooking, equipment repair, equipment maintenance and/or product assembly.

11. The CPP of claim 7 wherein the plurality of active sensors include a plurality of video cameras positioned to provide 360 degree visual coverage of the instance of the physical task.

12. The CPP of claim 7 wherein the plurality of active sensors include: at least one video camera, and (ii) at least one audio microphone.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving a plurality of training data sets for a physical task performed by a set of human(s), with each training data set including: (i) a plurality of streams of sensor input respectively received from a plurality of sensors over a common period of time, with each stream of sensor input including a plurality of sensor input values ordered in time, and (ii) an identification of a time of a first verification point instance corresponding to first intermediate event typically occurring within the performance of the physical task performed by human(s),
defining, by machine logic, a first verification point definition, with the first verification point definition including a plurality of parameter value ranges, with each parameter value range corresponding to a range of values in the stream of sensor input received from a sensor of the plurality of sensors that corresponds to an instance of the first verification point when the physical task is performed by a set of human(s),
monitoring, by a plurality of active sensors, an instance of the physical task as it is being performed by a set of human(s) to obtain a set of sensor stream parameter value(s) for each sensor of the plurality of active sensors,
determining, by machine logic, an occurrence of a first instance of the first verification point based on the plurality of parameter ranges of the first verification point definition and the set of sensor stream parameter value(s), and
responsive to the determination of the occurrence of the first instance of the first verification point, taking a responsive action.

14. The CS of claim 13 wherein the responsive action is the playing of a predetermined video for the set of human(s) performing the instance of the physical task.

15. The CS of claim 13 wherein the computer code further includes instructions for causing the processor(s) set to perform the following operation:
prior to the receiving of the receiving a plurality of training data sets and for each given training data set of the plurality of training data sets, identifying, by a human supervisor, the time of the first verification point instance.

16. The CS of claim 13 wherein the physical task relates to one of the following areas: cooking, equipment repair, equipment maintenance and/or product assembly.

17. The CS of claim 13 wherein the plurality of active sensors include a plurality of video cameras positioned to provide 360 degree visual coverage of the instance of the physical task.

18. The CS of claim 13 wherein the plurality of active sensors include: at least one video camera, and (ii) at least one audio microphone.
